(19) United States
(12) Patent Application Publication
(10) Pub. No.: US 2009/0265101 A1
(43) Pub. Date: Oct. 22, 2009

(54) Access Device With Navigation Function

(76) Inventor: En-Min Jow, Hsinchu (TW)

Correspondence Address: ESCHWEILER & ASSOCIATES, LLC;NATIONAL CITY BANK BUILDING, 629 EUCLID AVE., SUITE 1000, CLEVELAND, OH, 44114, US

(21) Appl. No.: 12/169,700

(22) Filed: Jul. 9, 2008

(30) Foreign Application Priority Data
Apr. 22, 2008 (TW) 97114678

(51) Int. Cl. G01C 21/34

(52) U.S. Cl. 701/209

(57) ABSTRACT

The present invention discloses an access device with a navigation function, which includes: a GPS module receiving a GPS signal from satellites; a processor coupled to the GPS module and processing GPS information; a storage unit coupled to the processor and storing the GPS information, map data and a navigation software; and a transmission interface coupled to the processor and implementing a computer device/electronic device to read data from/write data into the access device, wherein the computer device/electronic device communicates with the processor via the transmission interface to execute the navigation software using the GPS information and map data to navigate.

### BACKGROUND OF THE INVENTION

1. Field of the Invention

The present invention relates to a multi-function access device, particularly an access device with a navigation function.

2. Description of the Prior Art

PND (Portable Navigation Device) is growing popular and usually used to position or navigate vehicles. PND may be categorized into the portable type and the build-in type. However, the two types of PND both have the disadvantages of a small screen and operational inconvenience.

### SUMMARY OF THE INVENTION

One objective of the present invention is to solve the abovementioned problems via providing an access device with a navigation function, which is easy to operate and able to navigate in real time.

Another objective of the present invention is to provide an access device with a navigation function, wherein a GPS (Global Positioning System) module receives a GPS signal; a processor processes GPS information; a storage unit stores GPS information, map data and a navigation software; the access device communicates with a computer via an interface; and the computer executes the navigation software using the map data to navigate. Further, the access device also functions as a common storage drive able to store and access general data.

To achieve the abovementioned objectives, one embodiment of the present invention proposes an access device with a navigation function, which includes: a GPS module receiving a GPS signal from satellites; a processor coupled to the GPS module and processing GPS information; a storage unit coupled to the processor and storing the GPS information, map data and a navigation software; and a transmission interface coupled to the processor and implementing a computer device to read data from/write data into the access device, wherein the computer device communicates with the processor via the transmission interface to execute the navigation software using the GPS information and map data to navigate.

Another embodiment of the present invention proposes an access device with a navigation function, which includes: a GPS module receiving a GPS signal from satellites; a processor coupled to the GPS module and processing GPS information; a storage unit coupled to the processor and storing the GPS information, map data and a navigation software; and a transmission interface coupled to the processor and implementing an electronic device to read data from/write data into the access device, wherein the electronic device has a display unit, communicates with the processor via the transmission interface to execute the navigation software using the GPS information and map data to navigate, and presents navigation information on the display unit.

Below, the embodiments are described in detail in cooperation with drawings to make easily understood the objectives, technical contents, characteristics and accomplishments of the present invention.

### BRIEF DESCRIPTION OF THE DRAWINGS

FIG. 1 is a block diagram schematically showing the architecture of an access device with a navigation function according to one embodiment of the present invention; and

FIG. 2 is a block diagram schematically showing the architecture of an access device with a navigation function according to another embodiment of the present invention.

### DETAILED DESCRIPTION OF THE INVENTION

The present invention is to be described in detail below. However, it should be noted that the embodiments described below are only to exemplify the present invention but not to limit the scope of the present invention.

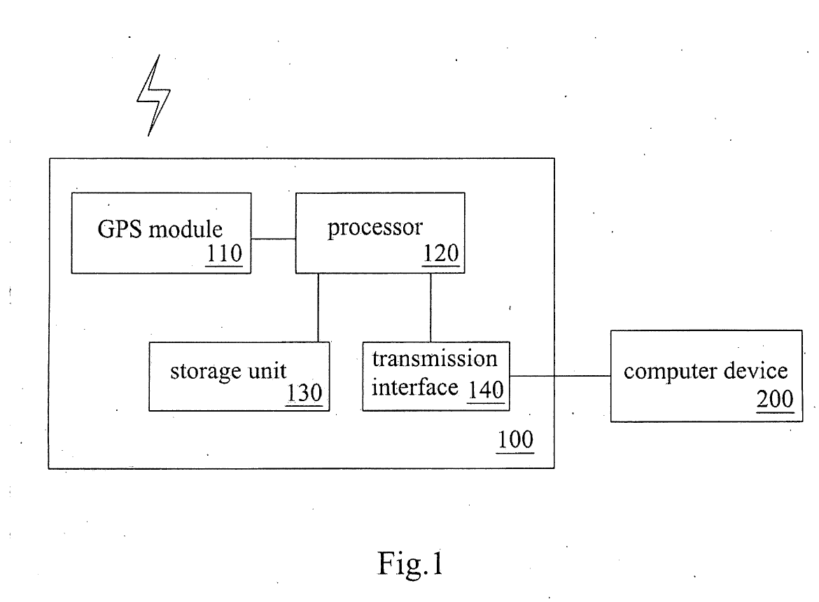

Refer to FIG. 1 a block diagram schematically showing the architecture of an access device with a navigation function according to one embodiment of the present invention. As shown in FIG. 1, the navigator access device 100 of the present invention includes: a GPS (Global Positioning System) module 110 receiving a GPS signal from satellites; a processor 120 coupled to the GPS module 110 processing received GPS information; a storage unit 130 coupled to the processor 120 storing map data, a navigation software and the GPS information coming from the satellites; a transmission interface 140 coupled to the processor 120 and implementing a computer device 200 or an electronic device to read data from/write data into the access device 100, wherein the computer device 200 or the electronic device communicates with the processor 120 via the transmission interface 140 to execute the navigation software using the GPS information and map data to navigate.

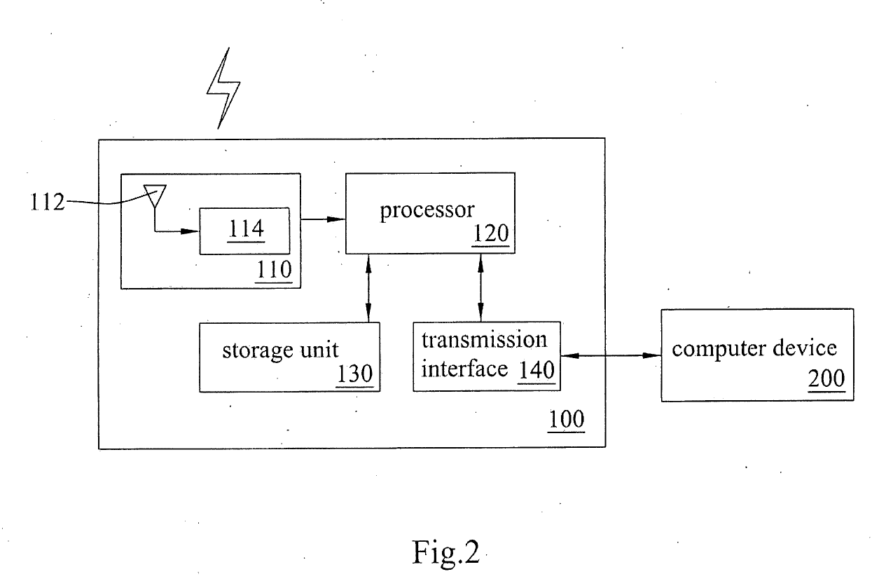

Refer to FIG. 2. In another embodiment of the present invention, the GPS module 110 further includes: a GPS antenna 112 and a GPS receiver 114. The GPS module 110 can learn the position of the user by receiving the GPS signal from the satellites with the GPS antenna 112 and the GPS receiver 114. The transmission interface 140 coupled to the computer device 200/electronic device is usually a USB (Universal Serial Bus) interface. The access device 100 generally has both CDC (Communication Device Class) and MSD (Mass Storage Device) programs. In yet another embodiment of the present invention, the transmission interface 140 may be an IEEE (Institute of Electrical and Electronics Engineers) 1394 interface, a USB interface, a SATA (Serial Advanced Technology Attachment) interface, an IDE (Integrated Drive Electronics) interface, an RS232 (Recommended Standard 232) interface, an SCSI (Small Computer System Interface) interface, a serial port, a parallel port or a wired transmission interface. In still another embodiment of the present invention, the transmission interface 140 may be an antenna, a radio transmission interface, an infrared transmission interface, a Bluetooth transmission interface, or another wireless transmission interface. The access device 100 can exchange data with the computer device 200/electronic device in a wired or wireless way. The computer device 200/electronic device may be a personal computer, a portable computer or PDA (Personal Digital Assistant).

When the user goes astray or wants to find a shortcut in a non-local area, he can immediately acquire navigation information by only linking the navigator access device 100 of the present invention to the computer device 200/electronic device via the transmission interface 140. The details are described below. After the computer device 200/electronic device has linked to the navigator access device 100, the computer device 200/electronic device reads and executes the navigation software stored in the storage unit 130 and presets the destination. The processor 120 transmits the GPS information and the map data to the computer device 200/electronic device. Then, the navigation software executed by the computer device 200/electronic device works out the shortcut and presents the result on the display unit of the computer device 200/electronic device. Thus, an outgoing user carrying about a notebook computer can easily arrive at his destination. Further, via the Internet, the access device 100 linking to the computer device 200/electronic device can easily update the navigation software and the map data, which is usually a necessary work in practical application. Besides, the navigation access device 100 can also function as a general storage drive, which is a design conveniencing the users.

Therefore, according to the above description, the access device with a navigation function of the present invention can exchange data with a computer device/electronic device in a wired or wireless way. Further, the access device linking to a computer device/electronic device can easily perform a necessary update of the navigation software and the map data, which provides much application flexibility for the users.

In conclusion, the present invention proposes an access device with a navigation function, which is easy to operate and able to navigate in real time, wherein a GPS module receives a GPS signal; a processor processes GPS information; a storage unit stores GPS information, map data and a navigation software; the access device communicates with a computer via an interface; and the computer executes the navigation software using the map data to navigate. Further, the access device also functions as a common storage drive able to store and access general data.

The embodiments described above are to demonstrate the technical thoughts and characteristics of the present invention to enable the persons skilled in the art to understand, make, and use the present invention. However, it is not intended to limit the scope of the present invention. Therefore, any equivalent modification or variation according to the spirit of the present invention is to be also included within the scope of the present invention.

What is claimed is:

1. An access device with a navigation function comprising:
a GPS (Global Positioning System) module receiving GPS information from satellites;
a processor coupled to said GPS module and processing said GPS information;
a storage unit coupled to said processor and storing said GPS information, map data and a navigation software; and
a transmission interface coupled to said processor and implementing a computer device to read data from/write data into said access device, wherein said computer device communicates with said processor via said transmission interface to execute said navigation software using said GPS information and said map data to navigate.

2. The access device with a navigation function according to claim 1, wherein said GPS module further comprises a GPS antenna and a GPS receiver.

3. The access device with a navigation function according to claim 1, wherein said transmission interface is an IEEE (Institute of Electrical and Electronics Engineers) 1394 interface, a USB (Universal Serial Bus) interface, a SATA (Serial Advanced Technology Attachment) interface, an IDE (Integrated Drive Electronics) interface, an RS232 (Recommended Standard 232) interface, an SCSI (Small Computer System Interface) interface, a serial port, a parallel port or another wired transmission interface.

4. The access device with a navigation function according to claim 1, wherein said transmission interface is an antenna, a radio transmission interface, an infrared transmission interface, a Bluetooth transmission interface, or another wireless transmission interface.

5. The access device with a navigation function according to claim 1, wherein said computer device is a personal computer or a portable computer.

6. The access device with a navigation function according to claim 1, wherein said computer device has a display unit.

7. An access device with a navigation function comprising:
a GPS (Global Positioning System) module receiving GPS information from satellites;
a processor coupled to said GPS module and processing said GPS information;
a storage unit coupled to said processor and storing said GPS information, map data and a navigation software; and
a transmission interface coupled to said processor and implementing an electronic device to read data from/write data into said access device, wherein said electronic device has a display unit, communicates with said processor via said transmission interface to execute said navigation software using said GPS information and said map data to navigate, and presents navigation information on said display unit.

8. The access device with a navigation function according to claim 7, wherein said GPS module further comprises a GPS antenna and a GPS receiver.

9. The access device with a navigation function according to claim 7, wherein said transmission interface is an IEEE (Institute of Electrical and Electronics Engineers) 1394 interface, a USB (Universal Serial Bus) interface, a SATA (Serial Advanced Technology Attachment) interface, an IDE (Integrated Drive Electronics) interface, an RS232 (Recommended Standard 232) interface, an SCSI (Small Computer System Interface) interface, a serial port, a parallel port or another wired transmission interface.

10. The access device with a navigation function according to claim 7, wherein said transmission interface is an antenna, a radio transmission interface, an infrared transmission interface, a Bluetooth transmission interface, or another wireless transmission interface.

11. The access device with a navigation function according to claim 7, wherein said electronic device is a personal computer, a portable computer, or PDA (Personal Digital Assistant).
